(19) United States
(12) Patent Application Publication
(10) Pub. No.: US 2025/0277545 A1
(43) Pub. Date: Sep. 4, 2025

(54) CROSSING BRIDGE AND METHOD

(71) Applicant: ADVANCED INNERGY LTD, Gloucester, England (GB)

(72) Inventor: Gregory Stanley VAN HINSBERGH, Gloucester, England (GB)

(21) Appl. No.: 18/858,690

(22) PCT Filed: Mar. 29, 2023
(86) PCT No.: PCT/GB2023/050806

§ 371 Date: Oct. 21, 2024

(30) Foreign Application Priority Data
May 5, 2022 (GB) 2206593.2
Nov. 7, 2022 (GB) 2216532.8

(51) Int. Cl. F16L 1/12; F16L 1/20

(52) U.S. Cl. CPC F16L 1/123; F16L 1/20

(57) ABSTRACT

A crossing bridge for subsea use and a method of installing the crossing bridge is provided. The crossing bridge comprises: a first passageway arranged to enable a first subsea conduit to pass under the crossing bridge; a second passageway arranged to enable a second subsea conduit to pass over the crossing bridge and over the first subsea conduit; one or more chambers for storing seawater when the crossing bridge is submerged in seawater; and one or more valves configured to enable seawater to enter the chamber when the crossing bridge is submerged in seawater.

### TECHNOLOGICAL FIELD

Embodiments of the present disclosure relate to a crossing bridge. Some relate to a crossing bridge for subsea use.

### BACKGROUND

Sometimes it is necessary for subsea conduits such as pipelines or cables to cross one another on the seabed. One conduit may cross another conduit such that the two conduits are perpendicular to one another.

If the conduits are not properly secured at the crossing, abrasion can occur, which may lead to a fault and a potential hazard. In some circumstances, one conduit may need to be thermally and electrically shielded from the other conduit. This might be the case, for example, if one of the conduits includes a high voltage power cable.

### BRIEF SUMMARY

According to various, but not necessarily all, embodiments there is provided a method, comprising: submerging a crossing bridge in seawater, wherein the crossing bridge comprises a shell having one or more chambers, defining one or more voids in the shell, into which seawater enters when the shell is submerged, and the shell further comprises a first passageway, arranged to enable a first subsea conduit to pass under the shell, and a second passageway, arranged to enable a second subsea conduit to pass over the shell and over the first subsea conduit; moving the crossing bridge into position such that the first subsea conduit passes under the shell and along the first passageway; and moving a second subsea conduit into position such that the second subsea conduit passes along the second passageway and over the first subsea conduit.

The method may further comprise: after submerging the crossing bridge in seawater, sealing the seawater in the one or more chambers.

The crossing bridge may further comprise one or more valves which enable the seawater to enter the one or more chambers. Sealing the seawater in the one or more chambers may comprise closing the one or more valves. The one or more valves may comprise one or more hydrophilic valves. Each of the hydrophilic valves may comprise at least one seal that expands in response to absorption of seawater and thereby closes the hydrophilic valve.

The crossing bridge may be submerged in the seawater by dropping the crossing bridge into the seawater.

Moving the crossing bridge into position may comprise moving the crossing bridge while the crossing bridge is submerged in seawater. The crossing bridge may be moved by a remotely operated underwater vehicle.

The method may further comprise: after moving the second subsea conduit into position such that the second subsea conduit passes along the second passageway and over the first subsea conduit, laying rocks over the first subsea conduit, the second subsea conduit and the crossing bridge.

The first passageway may be a tunnel under the crossing bridge.

At least a portion of the second passageway may be substantially perpendicular to at least a portion of the first passageway.

According to various, but not necessarily all, embodiments there is provided a method, comprising: submerging a crossing bridge in water, wherein the crossing bridge comprises a shell having one or more chambers, defining one or more voids in the shell, into which water enters when the shell is submerged, and the shell further comprises a first passageway, arranged to enable a first submerged conduit to pass under the shell, and a second passageway, arranged to enable a second submerged conduit to pass over the shell and over the first submerged conduit; moving the crossing bridge into position such that the first submerged conduit passes under the shell and along the first passageway; and moving a second submerged conduit into position such that the second submerged conduit passes along the second passageway and over the first submerged conduit.

The method may further comprise: after submerging the crossing bridge in water, sealing the water in the one or more chambers.

The crossing bridge may comprise one or more valves which enable the water to enter the one or more chambers. Sealing the water in the one or more chambers may comprise closing the one or more valves.

The one or more valves may comprise one or more hydrophilic valves. Each of the hydrophilic valves may comprise at least one seal that expands in response to absorption of water and thereby closes the hydrophilic valve.

The crossing bridge may be submerged in the water by dropping the crossing bridge into the water.

Moving the crossing bridge into position may comprise moving the crossing bridge while the crossing bridge is submerged in water. The crossing bridge may be moved by a remotely operated underwater vehicle.

The method may further comprise: after moving the second submerged conduit into position such that the second submerged conduit passes along the second passageway and over the first submerged conduit, laying rocks over the first submerged conduit, the second submerged conduit and the crossing bridge.

The first passageway may be a tunnel under the crossing bridge.

At least a portion of the second passageway may be substantially perpendicular to at least a portion of the first passageway.

According to various, but not necessarily all, embodiments there is provided a crossing bridge for subsea use, the crossing bridge comprising: a shell, comprising a first passageway arranged to enable a first subsea conduit to pass under the shell; a second passageway, defined at least in part by a floor of the shell, arranged to enable a second subsea conduit to pass over the shell and over the first subsea conduit; one or more chambers, defining one or more voids in the shell, for storing seawater when the shell is submerged in seawater; and wherein the crossing bridge further comprises: one or more valves configured to enable seawater to enter the one or more chambers when the shell is submerged in seawater.

The crossing bridge may further comprise at least one structural support configured to support the floor of the shell defining, at least in part, the second passageway.

In use, at least a portion of the floor of the shell may be located above the first passageway.

At least a portion of the structural support may be located above the first passageway. The structural support may at least partially define the first passageway. The structural support may be formed, at least in part, from at least one metal.

At least one chamber of the one or more chambers may be for storing at least one ballast. The crossing bridge may further comprise a plurality of walls arranged, at least in part, to define the second passageway.

The one or more valves may be located on an exterior surface of the crossing bridge. The one or more valves may be fluidly connected to the one or more chambers. The one or more valves may comprise one or more hydrophilic valves. Each of the hydrophilic valves may comprise at least one seal that is configured to expand in response to absorption of seawater and close the hydrophilic valve.

The first passageway may be a tunnel under the crossing bridge. At least a portion of the second passageway may be substantially perpendicular to at least a portion of the first passageway. The first passageway may comprise first and second tapered portions that enable the second subsea conduit to be positioned non-perpendicularly relative to the first subsea conduit. The crossing bridge may be an arch bridge.

According to various, but not necessarily all, embodiments there is provided a crossing bridge for submersion in a liquid, the crossing bridge comprising: a shell, comprising a first passageway arranged to enable a first submerged conduit to pass under the shell; a second passageway, defined at least in part by a floor of the shell, arranged to enable a second submerged conduit to pass over the shell and over the first submerged conduit; one or more chambers, defining one or more voids in the shell, for storing liquid when the shell is submerged in liquid; and wherein the crossing bridge further comprises: one or more valves configured to enable liquid to enter the one or more chambers when the shell is submerged in liquid.

According to various, but not necessarily all, embodiments there is provided examples as claimed in the appended claims.

### BRIEF DESCRIPTION

Some examples will now be described with reference to the accompanying drawings in which:

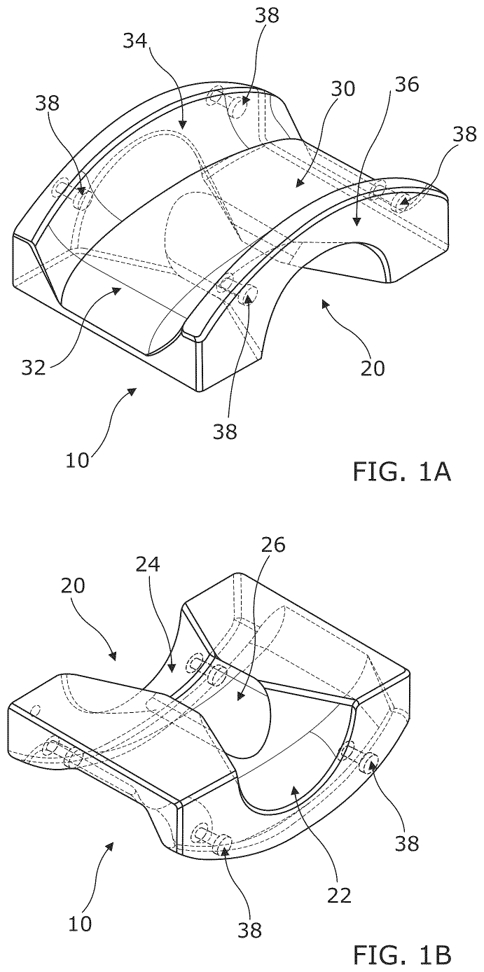

FIG. 1A illustrates a perspective view of a shell of a crossing bridge;

FIG. 1B illustrates a perspective view of an underside of the shell of the crossing bridge;

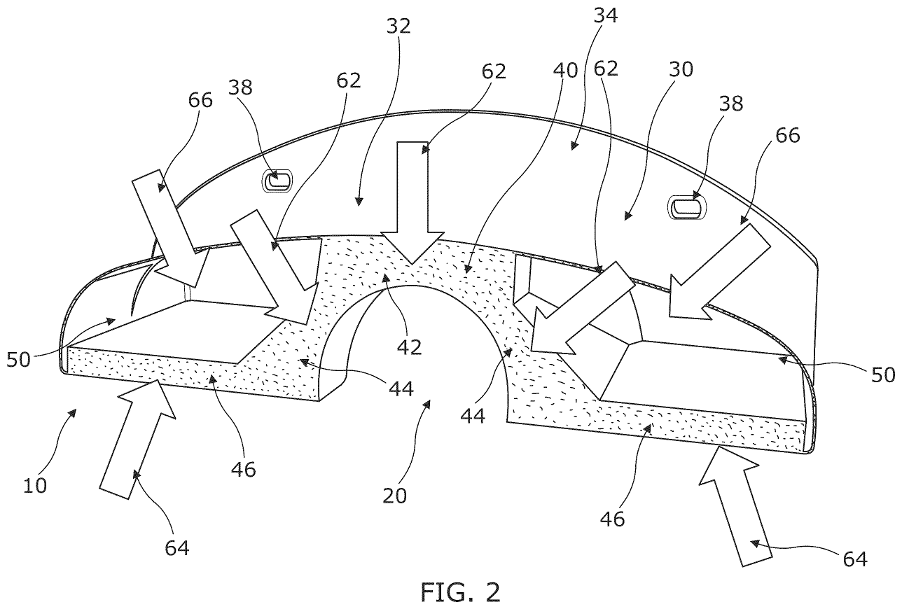

FIG. 2 illustrates a cross-sectional view of the shell of the crossing bridge comprising a chamber for storing seawater and a structural support;

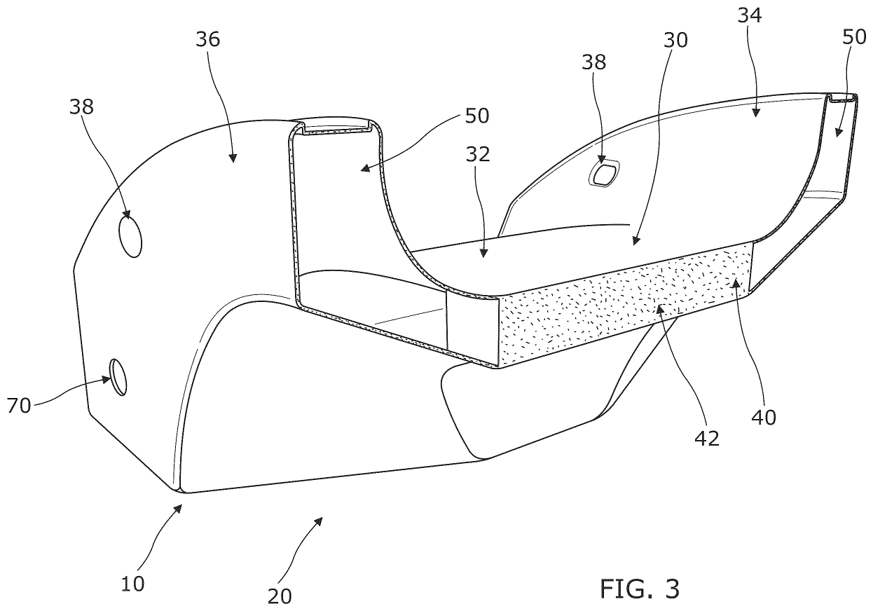

FIG. 3 illustrates another cross-sectional view of the shell of the crossing bridge illustrated in FIG. 2;

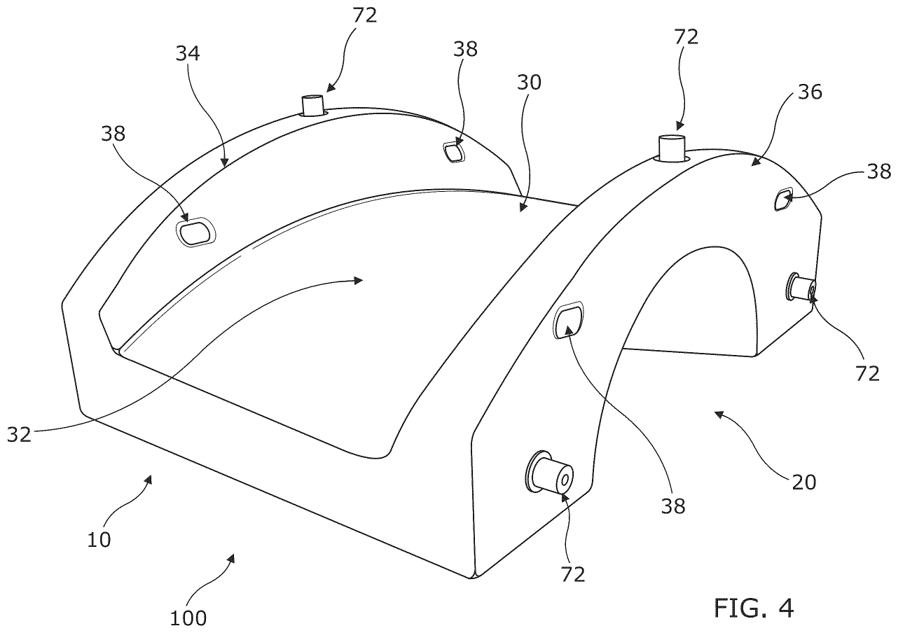

FIG. 4 illustrates a perspective view of the crossing bridge;

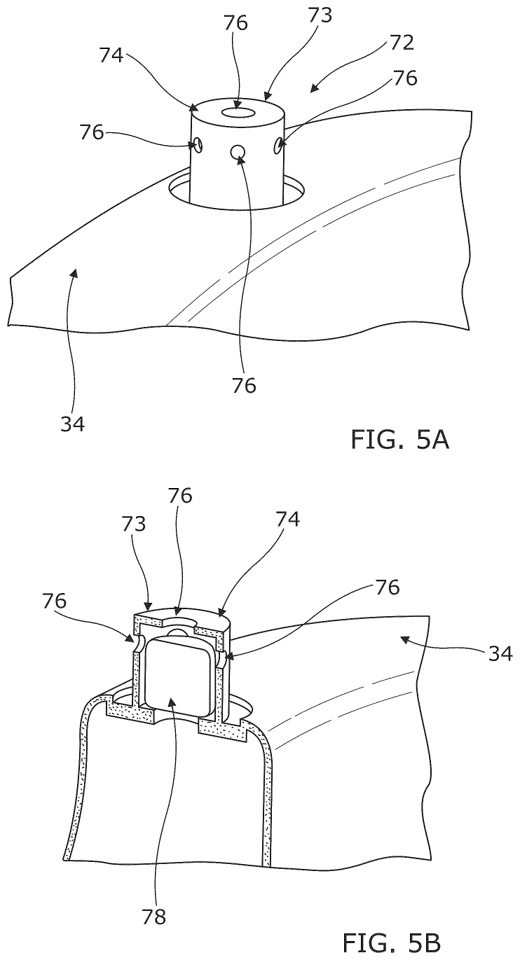

FIG. 5A illustrates a perspective view of a hydrophilic valve;

FIG. 5B illustrates a perspective view of a cross-section of the hydrophilic valve illustrated in FIG. 5A;

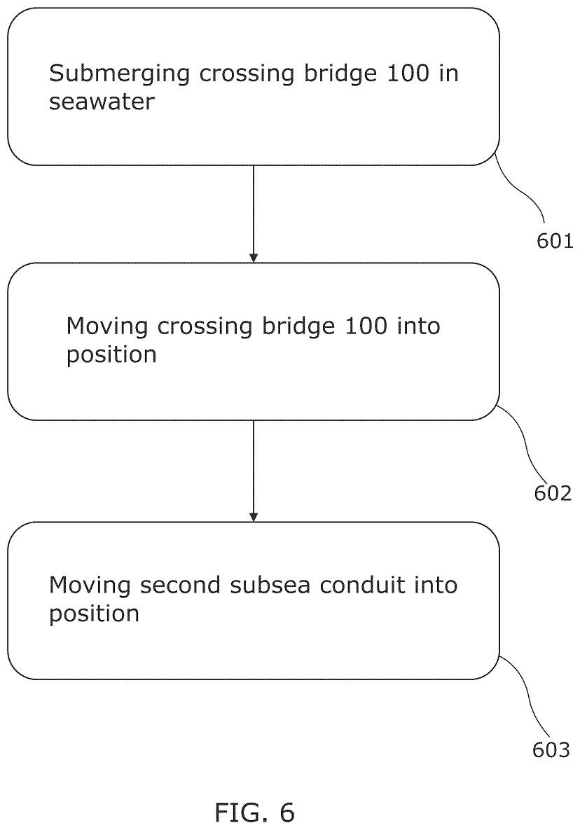

FIG. 6 illustrates a flow chart of a method;

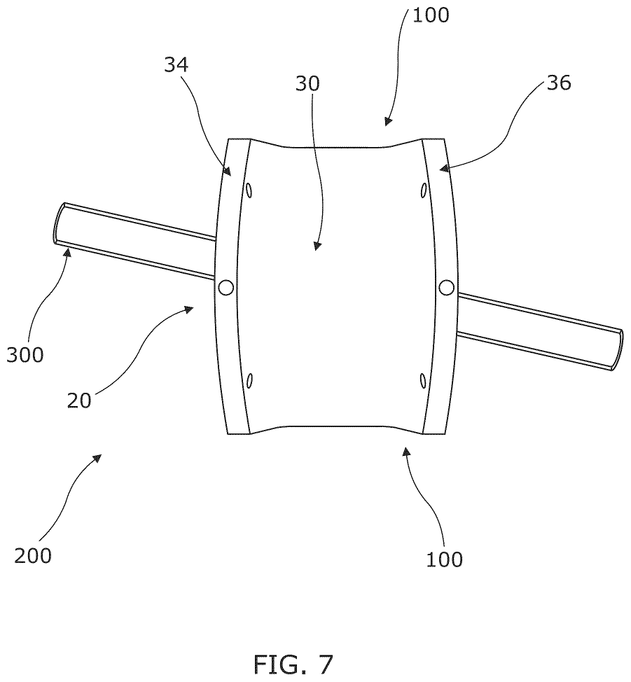

FIG. 7 illustrates a plan view of a schematic of the crossing bridge on the seabed, with a first subsea conduit passing under the crossing bridge on the seabed;

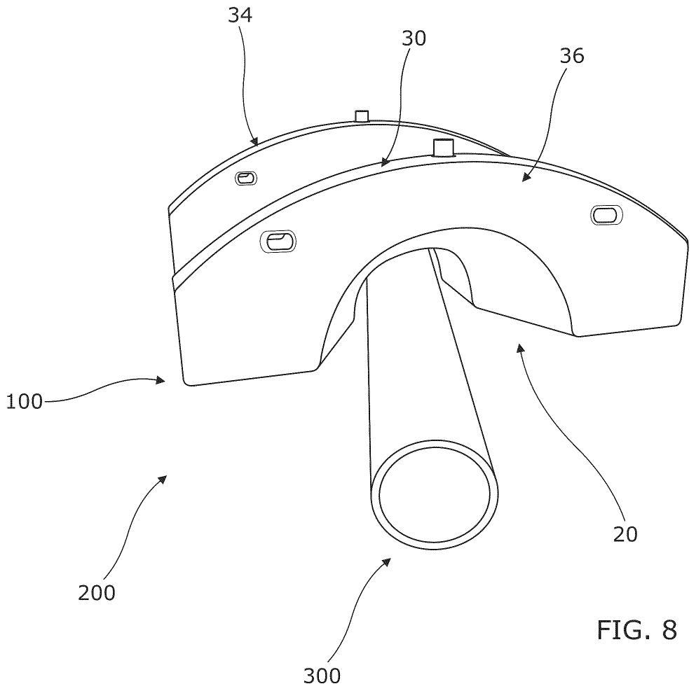

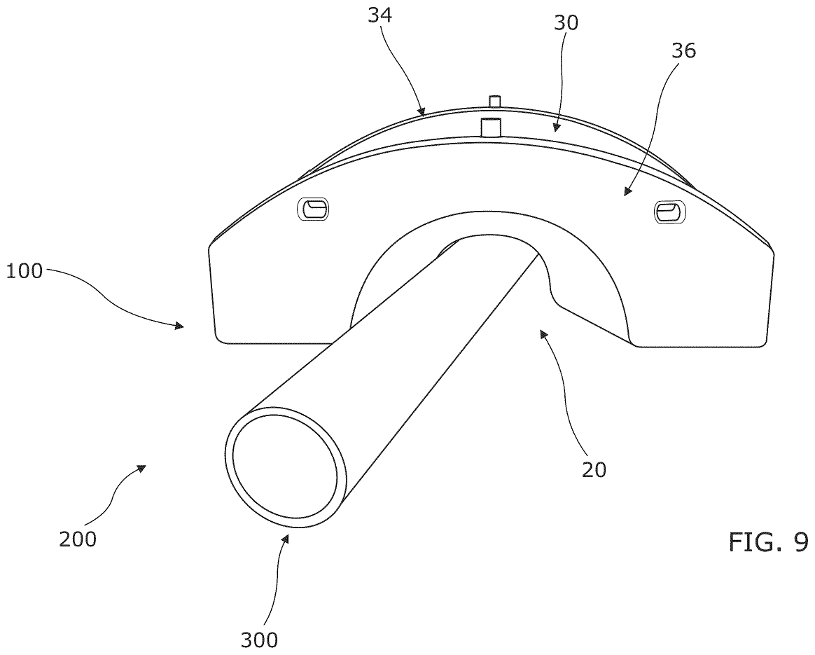

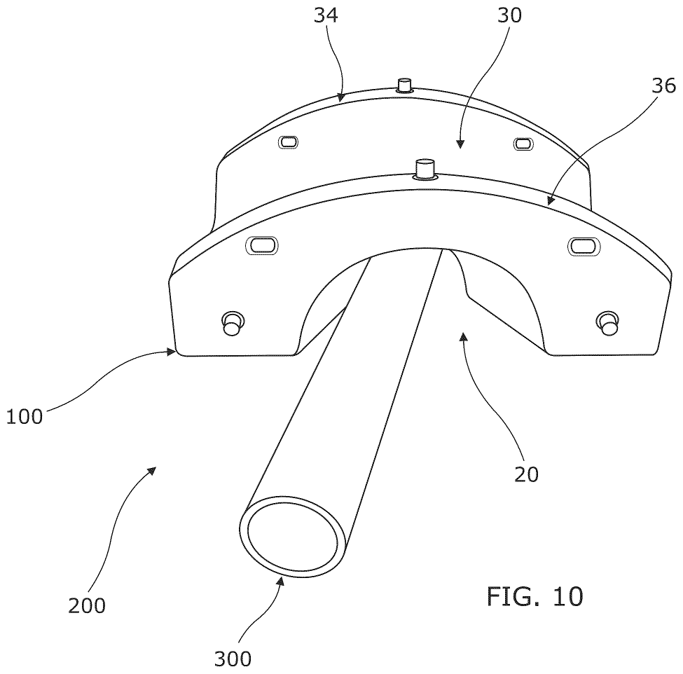

FIGS. 8, 9 and 10 illustrate front elevations of schematics of the crossing bridge on the seabed, with a first subsea conduit passing under the crossing bridge on the seabed at different angles.

### DETAILED DESCRIPTION

FIG. 1A illustrates a perspective view of a shell 10 of a crossing bridge. The shell 10, and therefore the crossing bridge, comprises a first passageway 20 and a second passageway 30.

The first passageway 20 is arranged to enable a first subsea conduit to pass under the crossing bridge. The first subsea conduit may be located on the seabed.

The first subsea conduit could, for example, be a pipeline for conveying a hydrocarbon mixture such as crude oil or natural gas. Alternatively, the first subsea conduit could be telecommunications cable comprising one or more optical fibres for conveying telecommunications signals, or an electrical cable such as a high voltage cable for conveying electrical power from a wind turbine.

In this example, the first passageway 20 is a tunnel under the crossing bridge. While the crossing bridge is an arch bridge in the illustration, it need not be in other examples. The shell 10 of the crossing bridge (and therefore the first passageway/tunnel 20) may have a different shape.

The second passageway 30 is arranged to enable a second subsea conduit to pass over the crossing bridge and over the first subsea conduit. The second subsea conduit could, for example, be a pipeline for conveying a hydrocarbon mixture such as crude oil or natural gas. Alternatively, the second subsea conduit could be a telecommunications cable comprising one or more optical fibres for conveying telecommunications signals, or an electrical cable such as a high voltage cable for conveying electrical power from a wind turbine. The second subsea conduit may be the same type of conduit as the first subsea conduit, or they may be of different types.

The second passageway 30 is arranged to extend over the first passageway 20. At least a portion of the second passageway 30 may be substantially perpendicular to at least a portion of the first passageway 20.

The first passageway 30 has a length which represents its longest extent. The second passageway 20 has a length which represents its longest extent. The length of the second passageway 30 is substantially perpendicular to the length of the first passageway 20 in the illustrated example.

The shell 10 comprises a floor 32 on which the second subsea conduit may be positioned. The second passageway 30 is defined, at least in part, by the floor 32. In the illustrated example, the floor 32 is curved/arched, although it need not be in every example. In use, at least a portion of the floor 32 is located above the first passageway 20.

In the illustrated example, the second passageway 30 is defined, at least in part, by a plurality of (lateral) walls 34, 36. Each of the walls 34, 36 extends upwardly. The floor 32 is located between the lateral walls 34, 36. The lateral walls 34, 36 are arranged to constrain the movement of the second subsea conduit when it is located on the floor 32. That is, the lateral walls 34, 36 are arranged to prevent the second subsea conduit from falling off the floor 32 when the second subsea conduit has been placed on it.

The shell 10 comprises a plurality of connectors 38. In the illustrated example, each of the connectors 38 is a through hole, but in other examples one, some or all of the connectors 38 may have a different form. The connectors 38 are arranged to enable the shell 10 to be lifted, for example, using a crane comprising a lifting sling. The crane may be used to position the shell 10 above the sea during installation.

The connectors 38 are located on the lateral walls 34, 36 in the illustrated example. In other examples they may be positioned elsewhere.

FIG. 1B illustrates a perspective view of an underside of the shell 10 of the crossing bridge in which the first passageway 20 is more clearly seen. In this example, the first passageway/tunnel 20 comprises first and second tapered portions 22, 24 and an intermediate portion 26. In the first tapered portion 22, the width of the first passageway 20 tapers inwardly from a first mouth of the first passageway 20 towards the intermediate portion 26 and the second tapered portion 24. In the second tapered portion 24, the width of the second passageway 20 tapers inwardly from a second mouth of the first passageway 20 towards the intermediate portion 26 and the first tapered portion 22.

In the illustrated example, the intermediate portion 26, which is located between the first and second tapered portions 22, 24, has a substantially constant width, but that might not be the case in other examples. In other examples, the intermediate portion 26 might not be present and first tapered portion 22 might be directly connected to the second tapered portion 24.

FIG. 2 illustrates a cross-sectional view of the shell 10 of the crossing bridge.

The shell 10, and therefore the crossing bridge, comprises one or more chambers 50 for storing seawater when the shell/crossing bridge is submerged in seawater. Each of the chambers 50 may define a void that can be filled with seawater. In the illustrated example, the shell 10 comprises a single chamber 50, but in other examples multiple separate chambers 50 may be provided.

In the example illustrated in FIG. 2, the crossing bridge comprises at least one structural support 40. A single structural support 40 is illustrated in FIG. 2, but multiple structural supports 40 may be provided in other examples. The structural support(s) 40 may be formed, at least in part, from at least one metal. For example, the support(s) 40 may be formed, at least in part, from steel or cast iron.

In some examples, the structural support 40 may be pre-formed and inserted into the shell 10. In other examples, one or more separate chambers 50 (i.e., separate from that/those which are used to store seawater) may be provided which can be filled with a ballast material to form the structural support 40. In still further examples, one or more chambers 50 may be provided which can optionally be used to store seawater, at least one ballast material and/or at least one buoyant material, depending on the application. The ballast material could be sand and/or a metal, such as iron ore.

In the illustrated example, the structural support 40 defines the first passageway/tunnel 20. That is, the structural support 40 defines the archway that forms the tunnel 20.

The structural support 40 is arranged to support the second passageway 30 and, more specifically, the floor 32 of the second passageway 30. The structural support 40 comprises one or more base portions 46, one or more floor supporting portions 42 and one or more interconnecting portions 44. The structure of the structural support 40 enables at least part of the weight of a second subsea conduit, located on the floor 32, to be transferred through to the seabed when the crossing bridge is located on the seabed. That is, it enables the weight to be transferred through the floor supporting portion(s) 42, the interconnecting portion(s) 44 and the base portion(s) 46 through to the seabed. Advantageously, the structure of the crossing bridge enables the weight of the second subsea conduit to be transferred to the seabed without being transferred to the first subsea conduit and without either the crossing bridge of the second subsea conduit being in contact with the first subsea conduit. The separation between the subsea conduits eliminates abrasion, reduces electrical interference and/or reduces heat transfer between the subsea conduits.

When the shell 10 is submerged in seawater, water enters the chamber(s) 50. This is described in further detail below. When seawater enters the chamber 50 and is sealed in the chamber 50, the chamber 50 becomes incompressible. That is, the floor 32 does not deform and thereby reduce the volume of the chamber 50 when a second subsea conduit is placed on the floor 32.

The arrows labelled with the reference numeral 62 in FIG. 2 illustrate part of the weight of second subsea conduit being borne by the floor supporting portion 42 and the interconnecting portions 44 of the structural support 40. The arrows labelled with the reference numeral 64 in FIG. 2 illustrate the support being provided through the base portions 46 of the structural support. The arrows labelled with the reference numeral 66 in FIG. 2 illustrate the support being provided due to the presence of the seawater in the chamber 50.

FIG. 3 illustrates another cross-sectional view of the shell 10 of the crossing bridge illustrated in FIG. 2. This view indicates how the chamber 50 extends through the shell 10, and in particular through the lateral walls 34, 36 of the shell 10.

FIG. 3 also illustrates that the shell 10 comprises one or more apertures 70 which provide access to the chamber 50. A valve may be located in each aperture 70. The valves may be configured to hermetically seal the chamber 50.

In examples in which the chamber(s) 50 are used to store ballast material and/or buoyant material, the apertures 70 may be used to insert the ballast material and/or buoyant material into the chamber(s) 50 (e.g., prior to the aperture being plugged or the insertion of a valve in the aperture 70).

FIG. 4 illustrates a perspective view of the crossing bridge 100, which comprises the shell 10 and one or more valves 72. Each of the one or more valves 72 is located in an aperture 70 in the shell 10. At least some of the one or more valves 72 may be configured to enable seawater to enter the chamber 50 when the crossing bridge 100 is submerged in seawater. At least some of the one or more valves 72 may be configured to enable air/gas to escape the chamber 50 when the crossing bridge is submerged in seawater. In this regard, each of the one or more valves 72 is fluidly connected to the chamber 50. It can be seen in FIG. 4 that the valves 72 are located on an exterior surface of the shell 10 and the crossing bridge 100.

It may be that at least one of the valves 72 is spaced, in a vertical dimension, from at least one of the other valves 72. In the illustrated example, multiple valves 72 are spaced in a vertical dimension from multiple other valves 72. That is, valves 72 on an upper surface of the lateral walls 34, 36 are spaced vertically from valves 72 on a side surface of the lateral walls 34, 36. At least a portion of the chamber 50 is located, in the vertical dimension, between the upper valves 72 and the lower valves 72. In some implementations, a majority or the whole of the chamber 50 is located between the upper valves 72 and the lower valves 72 in the vertical dimension.

In some examples, one, some or all of the valves 72 may be hydrophilic valves. It will be appreciated, however, that this need not be the case in every example. For instance, in other examples, one, some or all of the valves may be tidal flap valves.

FIG. 5A illustrates a perspective view of a hydrophilic valve 72. FIG. 5B illustrates a perspective view of a cross-section of the hydrophilic valve illustrated in FIG. 5A.

The hydrophilic valve 72 comprises a housing 73 having one or more apertures 76. The housing 73 defines a chamber 75 in which a seal 78, formed from a hydrophilic material, is located. The hydrophilic material may be a polymeric material.

The one or more apertures 76 act as inlets or outlets. For example, the apertures 76 may act as outlets by enabling air/gas located in the chamber 50 to escape the chamber 50 (via the chamber 75 defined by the housing 73) when the valve 72 is open. Alternatively, the apertures 76 may act as inlets to enable seawater to enter the chamber 75.

The seal 78 located in the chamber 75 is configured to expand in response to absorption of seawater and close the hydrophilic valve 72.

The seal 78 does not initially fill the volume of the chamber 75, prior to absorbing seawater. That is, part of the chamber 75 is a void. In response to absorption of the seawater, the seal 78 expands (for example, over the course of days or weeks) and eventually expands to a volume that causes the valve 72 to close, sealing the seawater in the chamber 50. This prevents seawater from exiting the chamber 50 (e.g., in response to a force being applied to the crossing bridge 100), rendering the chamber 50 incompressible.

FIG. 6 illustrates a method of installing the crossing bridge 100 in seawater. In block 601 of FIG. 6, the crossing bridge 100 is submerged in seawater. The crossing bridge 100 may be lifted by the connectors 38 (e.g., using a crane comprising a lifting sling) and located at an appropriate position above the surface of the sea, such that it can be dropped into position at the location at which it is desired to make a crossing over a first subsea conduit positioned on the seabed. Given the void(s) defined by the chamber(s) 50 of the crossing bridge 100, the crossing bridge 100 is relatively light to transport.

When the crossing bridge 100 is dropped into the sea and the crossing bridge 100 is at least partially submerged, seawater begins to enter the chamber(s) 50 via the valves 72 and air begins to exit the chamber(s) 50 via the valves 72. The seawater ingresses at the lower valves 72 and the air exhausts through the upper valves 72. The crossing bridge 100 is denser than the seawater, and sinks to seabed. The characteristics of the valves 72 and their location on the crossing bridge 100 will determine the speed at which the crossing bridge 100 sinks to the seabed.

Seawater will continue to enter the chamber(s) 50 until the chamber(s) 50 are substantially full with seawater. The period of time over which this occurs may depend on the nature of the valves 72 and could be a few hours. As mentioned above, the valves 72 may be configured to hermetically seal the chamber(s) 50. The period of time between the initial ingress of seawater and the valves 72 being hermetically sealed may depend on the nature of the valves 72. The hydrophilic valves 72 described above might take a few weeks to hermetically seal the chamber(s) 50.

In block 602 in FIG. 6, the crossing bridge 100 is moved into position such that the first subsea conduit passes along the first passageway 20, under the crossing bridge 100. The crossing bridge 100 may be moved, for example, by a remotely operated underwater vehicle. The crossing bridge 100 may be moved into position before or after the chamber(s) 50 are completely full with seawater. The crossing bridge 100 may be moved into position before or after the chamber(s) 50 have been sealed by the valves 72.

In block 603 in FIG. 6, a second subsea conduit is moved into position such that it passes along the second passageway 30, over the crossing bridge 100 and over the first subsea conduit.

The crossing point may then be fixed in position by laying rocks over the first subsea conduit, the second subsea conduit and the crossing bridge 100 at the location of the crossing point. Advantageously, the chamber(s) 50 of the crossing bridge 100 are incompressible during the positioning of the second subsea conduit and the laying of the rocks, due to ingress of seawater into the chamber(s) 50 and the hermetic sealing of the valves 72. In this regard, movement of the second subsea conduit into position and the laying of the rocks are both typically performed after the valves 72 have hermetically sealed the chamber(s) 50.

FIG. 7 illustrates a plan view of a schematic of the crossing bridge 100 on the seabed 200, with a first subsea conduit 300 passing through the first passageway 20. The first subsea conduit 300 is supported by and is in contact with the seabed 200.

FIGS. 8, 9 and 10 illustrate front elevations of schematics of the crossing bridge 100 on the seabed 200, with the first subsea conduit 300 passing through the first passageway 20. If a second subsea conduit were present, it would cross over the bridge 100. It can be envisaged from these figures that the first and second subsea conduits can be positioned non-perpendicularly relative to each other. This is enabled by the tapered portions 22, 24 of the first passageway 20.

It will be apparent to those skilled in the art that, while embodiments of the invention have been described in relation to use of the crossing bridge on a seabed, they are not limited to such an implementation. For instance, the crossing bridge could be employed in fresh water, or indeed in any liquid.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For instance, the structural support 40 might not be present in some examples.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavouring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

I/we claim:

1.-11. (canceled)

12. A method, comprising:
submerging a crossing bridge in water, wherein the crossing bridge comprises a shell having one or more chambers, defining one or more voids in the shell, into which water enters when the shell is submerged, and the shell further comprises a first passageway, arranged to enable a first submerged conduit to pass under the shell, and a second passageway, arranged to enable a second submerged conduit to pass over the shell and over the first submerged conduit;
moving the crossing bridge into position such that the first submerged conduit passes under the shell and along the first passageway; and
moving a second submerged conduit into position such that the second submerged conduit passes along the second passageway and over the first submerged conduit.

13. The method of claim 12, further comprising: after submerging the crossing bridge in water, sealing the water in the one or more chambers.

14. The method of claim 13, wherein the crossing bridge comprises one or more valves which enable the water to enter the one or more chambers, and sealing the water in the one or more chambers comprises closing the one or more valves.

15. The method of claim 14, wherein the one or more valves comprise one or more hydrophilic valves.

16. The method of claim 15, wherein each of the hydrophilic valves comprises at least one seal that expands in response to absorption of water and thereby closes the hydrophilic valve.

17. The method of claim 12, wherein the crossing bridge is submerged in the water by dropping the crossing bridge into the water.

18. The method of claim 12, wherein moving the crossing bridge into position comprises moving the crossing bridge while the crossing bridge is submerged in water.

19. The method of claim 18, wherein the crossing bridge is moved by a remotely operated underwater vehicle.

20. The method of claim 12, further comprising: after moving the second submerged conduit into position such that the second submerged conduit passes along the second passageway and over the first submerged conduit, laying rocks over the first submerged conduit, the second submerged conduit and the crossing bridge.

21. The method of claim 12, wherein the first passageway is a tunnel under the crossing bridge.

22. The method of claim 12, wherein at least a portion of the second passageway is substantially perpendicular to at least a portion of the first passageway.

23.-38. (canceled)

39. A crossing bridge for submersion in a liquid, the crossing bridge comprising:
a shell, comprising:
a first passageway arranged to enable a first submerged conduit to pass under the shell;
a second passageway, defined at least in part by a floor of the shell, arranged to enable a second submerged conduit to pass over the shell and over the first submerged conduit;
one or more chambers, defining one or more voids in the shell, for storing liquid when the shell is submerged in liquid; and
wherein the crossing bridge further comprises:
one or more valves configured to enable liquid to enter the one or more chambers when the shell is submerged in liquid.

40. The crossing bridge of claim 39, wherein the one or more valves comprise one or more hydrophilic valves.

41. The crossing bridge of claim 40, wherein each of the hydrophilic valves comprises at least one seal that is configured to expand in response to absorption of seawater and close the hydrophilic valve.

42. (canceled)

43. A crossing bridge for submersion in a liquid, the crossing bridge comprising:
a first passageway arranged to enable a first submerged conduit to pass under the crossing bridge;
a second passageway arranged to enable a second submerged conduit to pass over the crossing bridge and over the first submerged conduit;
one or more chambers for storing liquid when the crossing bridge is submerged in liquid; and
one or more valves configured to enable liquid to enter the one or more chambers when the crossing bridge is submerged in liquid.

44. The method of claim 12, wherein the water is seawater.

45. The crossing bridge of claim 39, further comprising at least one structural support configured to support the floor of the shell defining, at least in part, the second passageway.

46. The crossing bridge of claim 39, wherein, in use, at least a portion of the floor of the shell is located above the first passageway.

47. The crossing bridge of claim 43, wherein the one or more valves comprise one or more hydrophilic valves.

48. The crossing bridge of claim 47, wherein each of the hydrophilic valves comprises at least one seal that is configured to expand in response to absorption of seawater and close the hydrophilic valve.
